(19) United States
(12) Patent Application Publication
(10) Pub. No.: US 2017/0130030 A1
(43) Pub. Date: May 11, 2017

(54) NON-HALOGENATED FLAME RETARDANT UNSATURATED POLYESTER RESINS/COMPOSITES CONTAINING METAL PHOSPHONATE

(71) Applicant: ICL-IP America Inc., Tarrytown, NY (US)

(72) Inventors: Sergei Levchik, Croton-on-Hudson, NY (US); Seongchan Pack, Commack, NY (US)

(21) Appl. No.: 15/227,557

(22) Filed: Aug. 3, 2016

Related U.S. Application Data
(60) Provisional application No. 62/212,729, filed on Sep. 1, 2015.

(51) Int. Cl. C08K 5/5317

(52) U.S. Cl. CPC C08K 5/5317; C08K 2201/019

(57) ABSTRACT

Halogen-free flame retarded unsaturated polyester (UPE) composites are described, where aluminum methyl methylphosphonate (AMMP) was added to a UPE matrix in order to obtain a UL94-V0 formulation. The combustion properties of AMMP are improved to that of aluminum trihydrates (ATH) in cone calorimetry. The use of AMMP prepared with phosphonium catalyst was also shown to be advantageous for retaining the gelation time of the UPE resins in a mold.

### FIELD OF THE INVENTION

This invention relates to non-halogenated flame retarded unsaturated polyester (UPE) reins/composites in which a flame retardant, i.e., a metal phosphonate(s), The metal phosphonates act as a halogen-free flame retardant for UPE resins.

### BACKGROUND OF THE INVENTION

Since it is versatile in mold transformations, such as bulk molding compound (BMC) and sheet molding compound (SMC), unsaturated polyester resins (UPE) are widely used with fiber-fillers for transportation, construction and automotive applications. However, because of the nature of polymer chains and its composition, UPE resins are highly flammable and generate a sufficient amount of smoke in a fire. Therefore, flame retardants are added in order to reduce its flammability.

A typical halogenated flame retardant for UPE is bromine or chlorine-based flame retardants. Since the environmental regulations to the use of halogenated based flame retardants have been fortified, it confronts a situation of seeking out an alternative for UPE flame retardancy, which alternative should be more environmental and cost-effective. Aluminum hydrates (ATH) are a good candidate for flame retardants, in that endothermic reactions release water molecules to dilute the concentration of flammable gases in gas phases. In addition, the manufacturing cost of aluminum trihydrates is much lower than that of other flame retardants.

However, 55%-65% of ATH has to be added to a UPE matrix in order to obtain an appropriate value in flammability at with cone calorimetry or UL94 vertical tests. Such a high loading of the flame retardant can causes several problems including such problems as an increase in the viscosity of the solution/mixture and a decrease of gelation time. Eventually, the high loading of the flame retardant can deteriorate the physical properties of UPE composites. Therefore, there is an increased demand for the development of an advanced-flame retardant UPE composite, where a non-halogen flame retardant is environmentally friendly, cost-effective and has no influence on the UPE process at the mold transformations.

### BRIEF DESCRIPTION OF THE DRAWINGS

FIG. 1 is a graph of the Heat Release Rate (HRR) of pre-promoted orthophthalic-based unsaturated polyester (UPE)/Aluminum methyl phosphonate (AMMP)-phosphonium and UPE/ATH composites over time.

FIG. 2 is a graph of the HRR of UPE with 22.5% AMMP-phosphonium and UPE with 55.0 wt % Aluminum hydrates (ATH).

FIG. 3 portrays images of residues of UPE/AMMP-phosphonium UPE/ATH composites.

FIG. 4 portrays the images of residues of UPE with 22.5 wt % AMMP-phosphonium and UPE with 55.0 wt % ATH.

### DETAILED DESCRIPTION OF PREFERRED EMBODIMENTS

The metal phosphonate used herein can be a salt of alkyl alkylphosphonic acid or a salt of aryl alkylphosphonic acid. In one embodiment the salt of alkyl alkylphosphonic acid or salt of aryl alkylphosphonic acid can be such that the alkyl group and/or aryl group contains up to about 12 carbon atoms. In a further embodiment the metal phosphonate is represented by general formula (I):

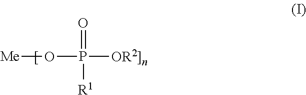

where Me is a metal, n is equal to the valency of the metal and is an integer of from 1 to 4, specifically 2 or 3, R¹ is a linear or branched alkyl of up to about 12 carbon atoms, specifically from up to about 4 carbon atoms, R² is a linear or branched alkyl of up to about 12 carbon atoms, specifically up to about 4 carbon atoms or a substituted aryl or an unsubstituted aryl of general formula (II):

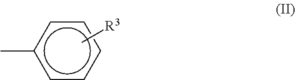

where R³ is hydrogen, or a branched or linear alkyl of up to about 4 carbon atoms, or an —NH₂, —CN or —NO₂ group.

In one specific embodiment, R¹ and/or R² are each independently methyl or ethyl radicals.

Metals, i.e., Me of the above formula (I), include alkaline earth or transition metals such as the non-limiting group consisting of Ca, Mg, Zn, Al, Fe, Ni, Cr, Ti. The most specific metal is Al.

In one embodiment the metal phosphonate of the formula (I) is an aluminum salt of methyl methylphosphonic acid (AMMP), where Me is aluminum, R¹ and R² are both methyl and n=3. AMMP contains a high level (i.e., 26 weight percent) of active phosphorus. AMMP can be synthesized either by reacting methyl methylphosphonate with an aqueous solution of sodium hydroxide followed by precipitation with aluminum chloride, or by a direct reaction of aluminum hydroxide with methyl methylphosphonate at about 180° C. in a presence of catalysts in a high shear mixer.

A phosphonium base catalyzed aluminum methyl methylphosphonate (AMMP-phosphonium) were obtained from the direct reaction of ATH with dimethly methylphosphonate (DMMP) at elevated temperatures in the presence of tetrabutylphosphonium bromide (Bu4PBr). More details in the preparation of the AMMP-phosphonium is herein reported:

### AMMP-Bu₄PBr:

94.6 kg (762.9 mol) of DMMP and 7.41 Kg (95 mol) of Al(OH)₃ were added to a reactor vessel. In addition, 55.6 g of tetra-n-butyl phosphonium bromide (Bu4PBr) was added. The reaction in the vessel was run for 9 hours at 174° C. At the end of the reaction, a vacuum was applied and the DMMP was removed. A total of 32.1 kg (95.5% yield) of product was removed from the vessel.

Furthermore, the time to gelation for UP resins/composites can be dependent on the types of catalysts. As a comparative catalyst for the gelation time, sodium salts, such as sodium carbonate (Na₂CO₃) and sodium hydroxide (NaOH) were selected and synthesized with ATH and DMMP in a reactor. A synthesis of AMMP-Na is described herein as comparative example for AMMP-phosphonium:

### AMMP-NaOH:

A 0.5 liter reactor with a jacket, equipped with an overhead stirrer, a thermometer and a setup for distillation, was charged, under stirring, with dimethylmethyl phosphonate (DMMP, 372 g, 3 mol), Al(OH)₃ (29.3 g, 0.375 mol) and NaOH catalyst (0.9 g). The reaction mixture was heated to 175° C. and then the reaction was complete after 5-7 h at the temperature, then the final reaction mixture was cooled to below 80° C. The white paste was diluted with methanol and then the slurry was filtered and dried in the vacuum oven to afford 126 g AMMP-NaOH in a 95% yield.

The time to gelation was dependent on the amount of the catalysts which was used in the AMMP process. 5 wt % of AMMP-phosphonium was applied in an orthophthalic-based UPE resin, where 0.5%, 1.0% and 2.0% Bu₄PBr were used at each AMMP-phosphonium. The use of 2.0% Bu₄PBr-based AMMP lowered the gel time to 18 minutes from 23 minutes for neat UPE resin. For the AMMP with 0.5% or 1.0% Bu₄PBr catalyst, the gel times were 24 minutes and 30 minutes, respectively. However, a sodium-based AMMP (AMMP-Na) delayed the gel time to above 90 minutes, which apparently did not make a gelation of the UPE/AMMP-Na mixture.

On the other hand, 15, 25 and 35 wt % of the AMMP-phosphonium was added in the UPE matrix in order to obtain a UL94-V0 formulation at 3.2 mm. A firm UL94-V0 formulation was obtained when 25 wt % AMMP-phosphonium was added in the polymer resins, whereas the same level of ATH content failed to the UL94-V0 criteria. The minimum loading of the AMMP-phosphonium was 22.5 wt % compared to 55% of ATH in order to achieve UL94-V0.

In cone calorimetry, the addition of AMMP-phosphonium showed a better performance on its flammability compared to ATH at the same loading levels. The peak HRR of the 25 wt % ATH was 312 kW/m², whereas the peak of the 25 wt % AMMP-phosphonium was 229 kW/m². The total of heat release of the UPE/AMMP phosphonium composite was also lower than that of UPE/ATH composite, which were 132 MJ/m² and 49 MJ/m², respectively.

### EXAMPLES

### Materials

a₁—Pre-promoted orthophthalic-based unsaturated polyester (UPE) EcoTekTMA541-CCAG-15, ex. Alpha Owens Corning (AOC)
b₁—Aluminum hydroxide, HJ-1000, ex. R.J. Marshall
c₁—Aluminum methyl methylphosphonate, AMMP—0.5% Bu₄PBr ex. ICL-IP
c₂—Aluminum methyl methylphosphonate, AMMP—1.0% Bu₄PBr ex. ICL-IP
c₃—Aluminum methyl methylphosphonate, AMMP—2.0% Bu₄PBr ex. ICL-IP
d₁—Aluminum methyl methylphosphonate, AMMP—1.5% Na₂CO₃ ex. ICL-IP
e₁—Aluminum methyl methylphosphonate, AMMP—2.0% NaOH ex. ICL-IP

### Sample Preparation

The mixture of UPE resin with AMMP was prepared by a blade-equipped mixer. First UPE liquid resin was added to a bowl of the mixer and then AMMP was added to the bowl. Then the mixture was stirred for 5-7 minutes at 50-60 rpm. The pasty mixture was transferred to a Teflon-coated mold and left under an air-circulated hood overnight to complete the reaction. A post-curing of the mixture was conducted at an air-circulated oven at 80° C. for 2 hours.

### Analytical Methods

Gelation time of flame retardant UPE composites: 5 wt % of either ATH or AMMP was added into a 3 oz beaker and then 95 wt % polyester was poured into the beaker with 0.423 grams methyl ethyl ketone peroxide (MEKP) as an accelerator. The mixture was immediately stirred by a magnetic stirring bar on a hot plate at room temperature. The time to gelation was measured until the stirring bar was stopped.

Hardness: Hardness of samples was measured by a Type A Durometer. The reported hardness was an average of 10 points of each of the samples. Each point had an interval of 5 mm.

UL94-V0 vertical flammable test: 10 specimens for each formulation were prepared in the UL94 protocol. The flammability test was conducted at an Altas Chamber. Max flame time, total flame time, dripping and burnt to Clamp were measured and observed. A UL94 grade was ranked for each formulation.

Cone calorimeter: Ø3.5 in. circular-shape of each formulation was prepared for cone calorimeter experiment. The incident heal flux was 50 kW/m² for all formulation. The combustion properties were peak heat release rate, heat release rate, total of heat release, mass loss rate, ignition time, specific extinction area and total smoke release. Images of the residues of each formulation were taken in an optical camera.

### Example 1-4 and Comparative Examples 1-3

Three AMMPs were used to measure the time to gelation. Each AMMP had different concentrations of Bu₄PBr catalyst used in the AMMP process, which were 0.5%, 1.0% and 2.0% The gel times for neat UPE was also measured as a comparative sample. From the Table 1, the time to gelation for 2.0% Bu4PBr was lowest among others. And, the gelation times for neat UPE and 1.0% Bu₄PBr were relatively same.

Three different catalysts-based AMMP were used for the measurement of gelation times. They were 1.5% sodium carbonate (Na₂CO₃), 2.0% sodium hydroxide (NaOH) and tetrabutylphosphonium bromide (Bu₄PBr). Their gelation times were tabulated at Table 1 along with values of the hardness. As seen in the table, the two sodium-based AMMP (AMMP-Na) took above 90 minutes to obtain a gelation of the UPE resin. As a result, the hardness of either AMMP-Na₂CO₃ or AMMP-NaOH was lower than that of the AMMP-Bu₄PBr.

### Examples 5-18

A UL94-V0 vertical flammable test was conducted with a series of both UPE/AMMP-phosphonium and UPE/ATH composites, where a minimum loading level of each flame retardant was found for obtain a V-0 formulation. As seen in Table 2, a minimum level of loaded ATH was 55 wt %. However, for AMMP-phosphonium the minimum loading level was 22.5 wt %.

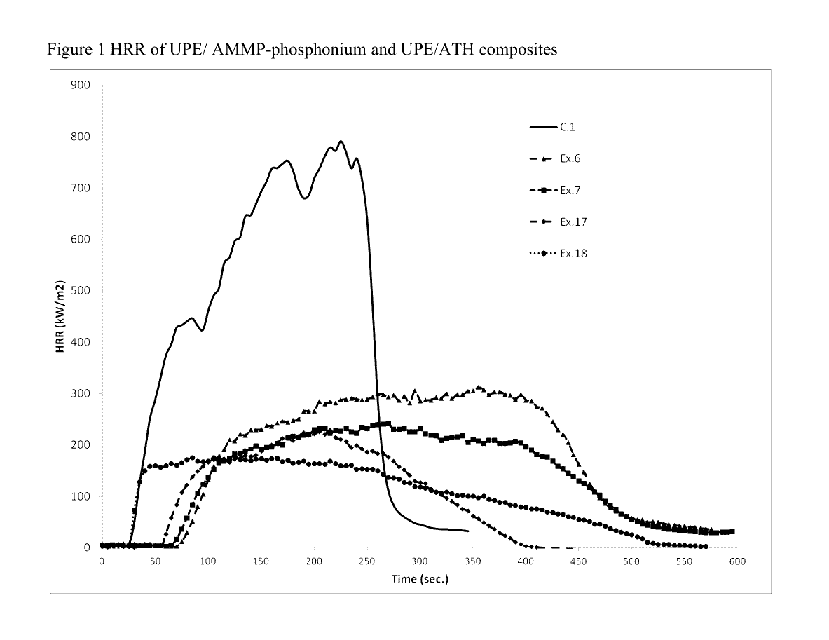

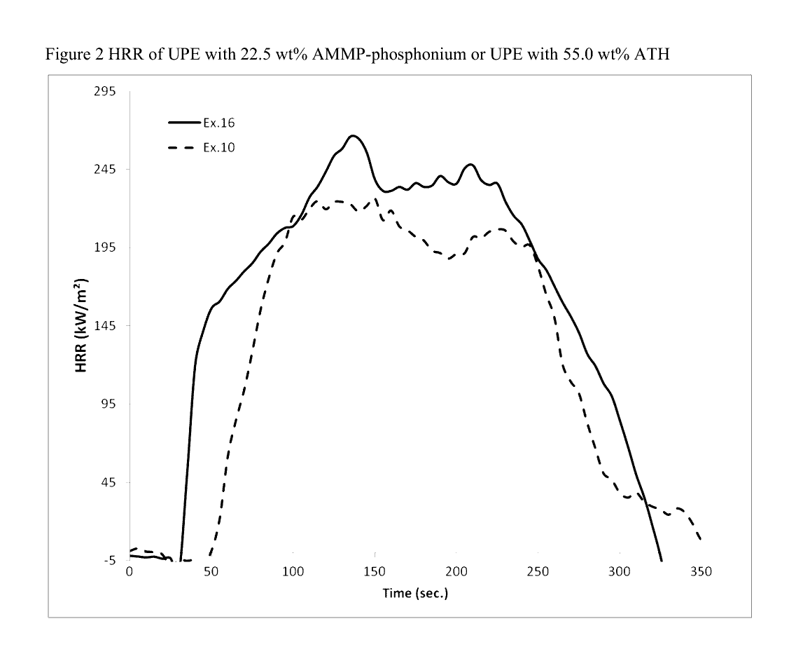

A cone calorimeter was used for the measurement of combustion properties of UPE/AMMP-phosphonium and UPE/ATH composites. The selected concentrations of each flame retardant were 25 wt % and 35 wt %. As seen in Table 2, overall, the combustion properties of UPE/AMMP-phosphonium were better than that of UPE/ATH. In particular, both the peak HRR and the total of heat release of UPE/-phosphonium much lower than those of UPE/ATH composites. All HRR curves of UPE/AMMP-phosphonium and UPE/ATH composites were shown in FIG. 1. Moreover, as an observation in the residues after cone calorimeter experiments, the solid residues were fully covered over the sample containers in the cases of UPE/AMMP-phosphonium, which was shown in FIG. 2.

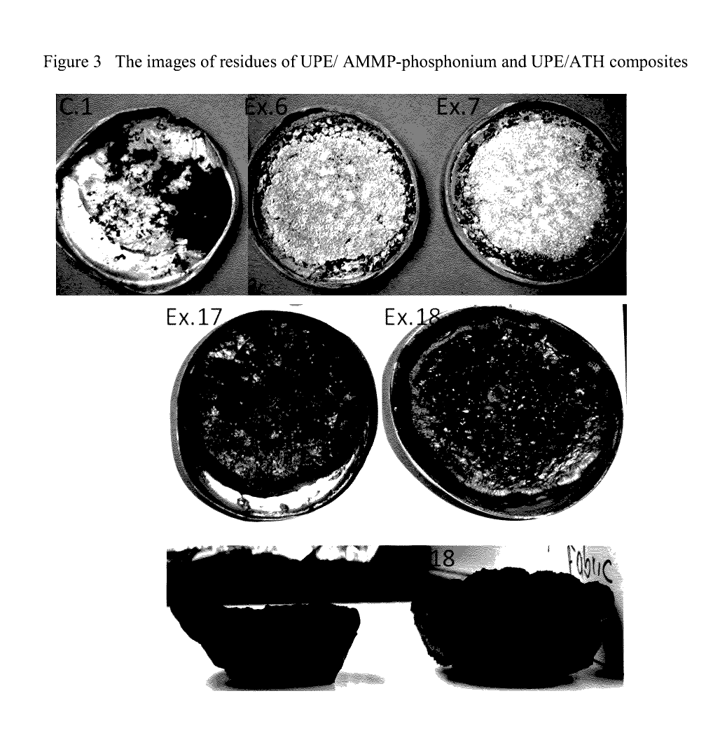

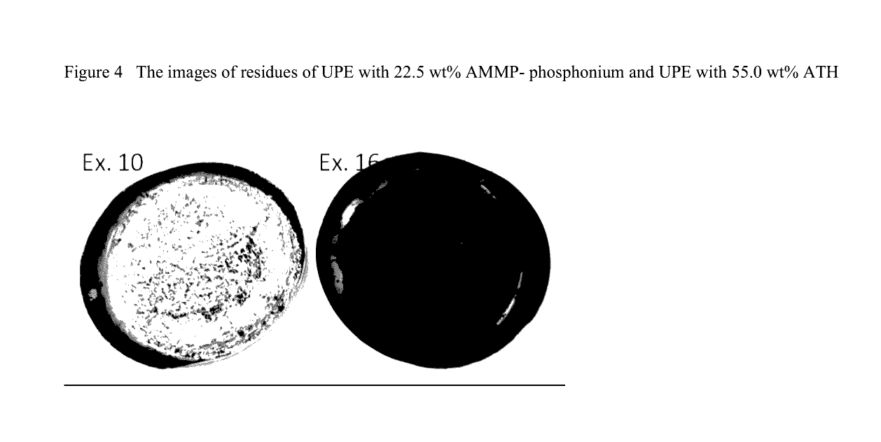

Another cone calorimeter experiment was conducted with the samples of 55 wt % ATH and 22.5 wt % AMMP-phosphonium at which concentration showed that both composites passed to the UL94 V-0 criteria. As seen in Table 2, the combustion properties of the two composites were also very similar. Both HRR curves were shown in FIG. 3. And, the solid residue of the 22.5 wt % AMMP-phosphonium composite was fully covered in the sample container, which was shown in FIG. 4.

TABLE 1
Gel time and Hardness of UPE composites with different
flame retardants.

| Example | C. 1 | Ex. 1 | Ex. 2 | Ex. 3 | Ex. 4 | C. 2 | C. 3 |
|---|---|---|---|---|---|---|---|
| a₁ | 100 | 95 | 95 | 95 | 95 | 95 | 95 |
| b₁ | | 5 | | | | | |
| c₁ | | | 5 | | | | |
| c₂ | | | | 5 | | | |
| c₃ | | | | | 5 | | |
| d₁ | | | | | | 5 | |
| e₁ | | | | | | | 5 |
| Gel time (min.) | 22 | 23 | 30 | 24 | 18 | >90 | >90 |
| Shore A Hardness | | | | 94 | | 89 | 89 |

TABLE 2
UL94 and combustion properties of flame retarded UPE compositions

| Example | C. 1 | Ex. 5 | Ex. 6 | Ex. 7 | Ex. 8 | Ex. 9 | Ex. 10 | Ex. 11 | Ex. 12 | Ex. 13 | Ex. 14 | Ex. 15 | Ex. 16 | Ex. 17 | Ex. 18 |
|---|---|---|---|---|---|---|---|---|---|---|---|---|---|---|---|
| a₁ | 100 | 85 | 75 | 65 | 60 | 50 | 45 | 40 | 35 | 85 | 82.5 | 80 | 77.5 | 75 | 65 |
| b₁ | | 15 | 25 | 35 | 40 | 50 | 55 | 60 | 65 | | | | | | |
| c₂ | | | | | | | | | | 15 | 17.5 | 20 | 22.5 | 25 | 35 |
| UL94, | Fail | Fail | Fail | Fail | Fail | Fail | V-0 | V-0 | V-0 | Fail | Fail | V-1 | V-0 | V-0 | V-0 |
| (3.2 mm) | | | | | | | | | | | | | | | |
| *Dripping | BD | BTC | BTC | BTC | BTC | BTC | N | N | N | BTC | BTC | N | N | N | N |
| **PHRR, | 791 | | 312 | 241 | | | 226 | | | | | | 266 | 229 | 179 |
| kW/m² | | | | | | | | | | | | | | | |
| HRR, | 433 | | 197 | 151 | | | 160 | | | | | | 191 | 117 | 108 |
| kW/m² | | | | | | | | | | | | | | | |
| MLS, | 0.18 | | 0.09 | 0.08 | | | 0.06 | | | | | | 0.09 | 0.09 | 0.07 |
| g/s · m² | | | | | | | | | | | | | | | |
| THR, | 137 | | 103 | 82 | | | 43 | | | | | | 54 | 49 | 59 |
| MJ/m² | | | | | | | | | | | | | | | |
| TTG, sec. | 27 | | 46 | 47 | | | 50 | | | | | | 35 | 28 | 24 |
| SEA, | 1020 | | 831 | 898 | | | | | | | | | | 1139 | 1139 |
| m²/kg | | | | | | | | | | | | | | | |
| TSR, | 7645 | | 5155 | 5398 | | | | | | | | | | 5910 | 5628 |
| m²/m² | | | | | | | | | | | | | | | |

*BD: Burning Drip; D: Dripping; N: No Dripping; BTC: Burn To the Clamp.
**PHRR: Peak Heat release rate; HRR: Heat release rate; MLS: Mass loss rate; THR: Total of heat release; TTG: Time to ignition; SEA: Specific extinction area; TSR: Total smoke release.

1. A flame retarded unsaturated polyester composition comprising at least one unsaturated polyester and at least one metal phosphonate.

2. The flame retarded unsaturated polyester composition of claim 1 where the unsaturated polyester is selected from the group consisting of ortho resins, iso resins, bisphenol-A fumarate, chlorendics, vinyl resins and combination thereof.

3. The flame retarded unsaturated polyester composition of claim 2 where the unsaturated polyester is orthophthalic-based unsaturated polyester.

4. The flame retarded unsaturated polyester composition of claim 1 where the metal phosphonate is represented by general formula (I): 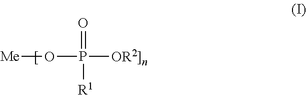
where Me is a metal, n is equal to the valency of the metal and is an integer of from 1 to 4, R¹ is a linear or branched alkyl group containing up to about 12 carbon atoms and R² is a linear or branched alkyl group containing up to about 12 carbon atoms or an aryl of general formula (II): 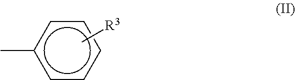
wherein R³ is hydrogen, a linear or branched alkyl group containing up to about 4 carbon atoms, an —NH₂ group, a —CN group or an —NO₂ group.

5. The flame retarded unsaturated polyester composition of claim 1 where the metal phosphonate is aluminum methyl methylphosphonate.

6. The flame retarded unsaturated polyester composition of claim 1 wherein the metal phosphonate is a phosphonium base catalyzed aluminum methyl methylphosphonate.

7. The flame retarded unsaturated polyester composition of claim 1 wherein the phosphonium base catalyzed aluminum methyl methylphosphonate is obtained from the direct reaction of ATH with dimethly methylphosphonate (DMMP) at elevated temperatures in the presence of tetrabutylphosphonium bromide (Bu₄PBr).

6. The flame retarded unsaturated polyester composition of claim 1 where the unsaturated polyester is present in the amount of from about 20 wt. % to about 90 wt. % and the metal phosphonate is present in the amount of from about 5 wt. % to about 50 wt. % based on the total weight of the flame retarded unsaturated polyester composition.

7. The flame retarded unsaturated polyester composition of claim 1 where the unsaturated polyester is present in the amount of from about 65 wt. % to about 80 wt. % and the metal phosphonate is present in the amount of from about 20 wt. % to about 35 wt. % based on the total weight of the flame retarded unsaturated polyester composition

8. An article comprising the flame retarded unsaturated polyester composition of claim 1.

9. A reinforced composite comprising the flame retarded unsaturated polyester composition of claim 1.

10. A process of making a flame retarded unsaturated polyester composition comprising contacting at least one unsaturated polyester and at least one metal phosphonate to provide a flame retarded unsaturated polyester composition.

11. A flame retarded unsaturated polyester made by the process of claim 10.

12. An article comprising the flame retarded unsaturated polyester of claim 11.

13. The article of claim 12, wherein the article is a reinforced composite.
